(19) United States
(12) Patent Application Publication
(10) Pub. No.: US 2018/0346241 A1
(43) Pub. Date: Dec. 6, 2018

(54) SIDE LOADING AUTOMATED RUBBISH BIN COLLECTION SYSTEM

(71) Applicant: Superior Pak Holdings Pty Ltd, Queensland (AU)

(72) Inventors: Rowland ERRINGTON, Queensland (AU); Michael PRONGER, Queensland (AU)

(21) Appl. No.: 15/761,608

(22) PCT Filed: Sep. 28, 2016
(86) PCT No.: PCT/AU2016/050906

§ 371 Date: Mar. 20, 2018

(30) Foreign Application Priority Data
Sep. 29, 2015 (AU) 2015903950

(51) Int. Cl. B65F 3/04

(52) U.S. Cl. CPC B65F 3/04; B65F 2003/025

(57) ABSTRACT

An automated rubbish bin collection system for a garbage truck having a detection means to detect the presence of a rubbish bin, a control means to receive input from the detection means and process the input to control the collection of a rubbish bin, and an actuation means to actuate the movement of the lifting arm to grab, lift and empty the rubbish from the rubbish bin into a hopper of the rubbish collection vehicle, wherein from the detection of the presence of the rubbish bin a coordinated sequence of steps automatically occurs to collect the rubbish bin, move the rubbish bin, empty the rubbish into the hopper and return the rubbish bin to the initial position.

### FIELD OF INVENTION

The present invention relates to the collection of rubbish bins and in particular to the collection of rubbish bins by rubbish collection vehicles. The invention has broad application to the repetitive collection of items by vehicles and the invention is not limited to the collection of rubbish bins by rubbish collection vehicles.

### BACKGROUND OF THE INVENTION

The rubbish from a rubbish bin is collected by a rubbish collection vehicle which uses a lifting arm that extends, grabs the bin and lifts the bin to empty the rubbish into the vehicle's hopper and then return the bin to its original position. The lifting arm is controlled with a joystick and buttons by the driver. The alignment of the lifting arm with the rubbish bin is manually controlled by the driver and the efficiency of alignment and rubbish collection depends on the experience and skill competency of the driver.

Within a group of drivers there is a range of efficiencies in the collection of rubbish. It is desirable to increase the efficiency of rubbish collection and have reproducible efficiencies in the collection of rubbish from rubbish bins. With current methods the efficiency of rubbish collection is variable and inconsistent.

Drivers also suffer from repetitive strain injuries with the continual use of the joystick and buttons. Consequently a driver's efficiency in collecting rubbish from a rubbish bin decreases when they suffer from a repetitive strain injury to their hand and often the drivers require leave to rest the hand and recover from the injury. Consequently there is always a need to employ more drivers and work with them to improve their skill level in collecting rubbish while minimizing their risk of injury.

### OBJECT OF THE INVENTION

It is an object of the present invention to provide an automated rubbish bin collection system for a rubbish collection vehicle that overcomes at least in part one or more of the above mentioned problems.

### SUMMARY OF THE INVENTION

In one aspect the present invention broadly resides in an automated rubbish bin collection system including

detection means to detect the presence of a rubbish bin;

control means to receive input from the detection means and process the input to control the collection of a rubbish bin; and

actuation means to actuate the movement of the lifting arm to grab, lift and empty the rubbish from the rubbish bin into a hopper of a rubbish collection vehicle, wherein from the detection of the presence of the rubbish bin a coordinated sequence of steps automatically occurs to collect the rubbish bin, move the rubbish bin, empty the rubbish into the hopper and return the rubbish bin to the initial position.

The detection means preferably includes one or more sensors to determine the presence of the rubbish bin. More preferably the detection means includes one or more sensors to determine the relative position of the rubbish bin and provide input to the control means. In one form the one or more sensors include a laser distance sensor and or a camera system. Where there is a camera system preferably there is a viewing screen within the vehicle cabin.

In one embodiment there are also one or more sensors to determine the type of rubbish bin so that the correct hopper can be selected automatically for the rubbish of that bin type. For example, where the rubbish bin has a yellow lid, the detection means sensor detects the yellow lid and the input from the detection means sensor is processed to coordinate the opening of the correct hopper for the collection of recyclable rubbish.

The control means preferably includes processor means that receives the input from the one or more sensors, processes the input in accordance with programming of the processor means and sends actuation signals to the actuation means. Preferably the control means provides one or more audible or visual signals to the driver to advise of the stage of the rubbish collection.

The actuation means preferably includes extension and retraction of a lifting arm, grabbing and release of a rubbish bin by the lifting arm, and raising and lowering of the lifting arm. The actuation means preferably includes moving the lifting arm in any suitable position to empty the rubbish from the rubbish bin in the preferred hopper. More preferably the control means coordinates the movement of the lifting arm to sequentially reach for the rubbish bin, lift the rubbish bin, empty the rubbish from the rubbish bin, lower the lifting arm, release the rubbish bin and retract the lifting arm.

Preferably the driver can initiate the collection process when the vehicle is in an appropriate position relative to the target rubbish bin. The appropriate position relative to the target rubbish bin can be any position where the prescribed parameters are met for the commencement of the operation of the collection process. The prescribed parameters can include distance from bin and braking of the vehicle.

In one embodiment, the prescribed parameters may only be met when the lifting arm is opposite the bin. In another embodiment, the automated collection process may be initiated when the vehicle commences braking or when it is within a set distance from the target bin. In this embodiment the target bin may be recognized by lid colour or detection of an electronic tag such as an RFID tag.

The automated collection process can preferably be initiated and continue after the target bin has been emptied if the next target bin is within a predetermined distance from the last target bin. Alternatively, the function of continuous bin pickup may be optional and at the discretion of the driver or operator. By way of example, target bins are generally spaced within 20 meters of each other in the city while in the country the target bins are generally spaced further apart from each other, thereby providing different conditions for bin pick up and possible use of different continuous pick up options.

In one form, initiation is achieved by pressing a button or switch that is on the floor, dashboard, console, or steering wheel. Pressing the button or switch electronically actuates the automated rubbish bin collection system.

Preferably the automated system is not engaged or disengaged when the driver uses the joystick or associated buttons, or if the automated system has been paused longer than for a predetermined period.

In another aspect the invention broadly resides in an automated rubbish bin collection system for a rubbish collection vehicle as described above and includes:

vehicle control means which controls the movement of the vehicle when the presence of the rubbish bin is detected to position the vehicle so that the lifting arm aligns with the rubbish bin so the rubbish bin can be raised and lowered to empty rubbish into the hopper.

Preferably the vehicle control means is automatically initiated and controls the vehicle when the presence of the rubbish bin is detected. Preferably the control of the vehicle by the vehicle control means is not engaged or is disengaged when the vehicle exceeds a predetermined speed, if the brake is applied by the driver, if the rubbish bin is beyond a predetermined distance from the vehicle and or if the driver accelerates the vehicle.

In a further aspect the present invention broadly resides in a method of collecting rubbish using a rubbish collection vehicle and employing the abovementioned automated rubbish bin collection system, including the steps of:

positioning the rubbish collection vehicle adjacent the rubbish bin to align the lifting arm with the rubbish bin;

moving the lifting arm to grab and lift the rubbish bin to empty the rubbish and then lower the rubbish bin; wherein the steps occur in an automatic and sequential manner after the presence of the rubbish bin has been detected.

The features described with respect to one aspect also apply where applicable to all other aspects of the invention. Furthermore different combinations of described features are herein described and claimed even when not expressly stated.

### BRIEF DESCRIPTION OF THE DRAWINGS

In order that the present invention can be more readily understood reference will now be made to the accompanying drawings which illustrate a preferred embodiment of the invention and wherein:

FIG. 1 is a flow diagram of the system to collect a rubbish bin by a rubbish collection vehicle; and

FIG. 2 is a flow diagram of part of the system to collect a rubbish bin by a rubbish collection vehicle as shown in FIG. 1.

### DETAILED DESCRIPTION OF THE PREFERRED EMBODIMENT

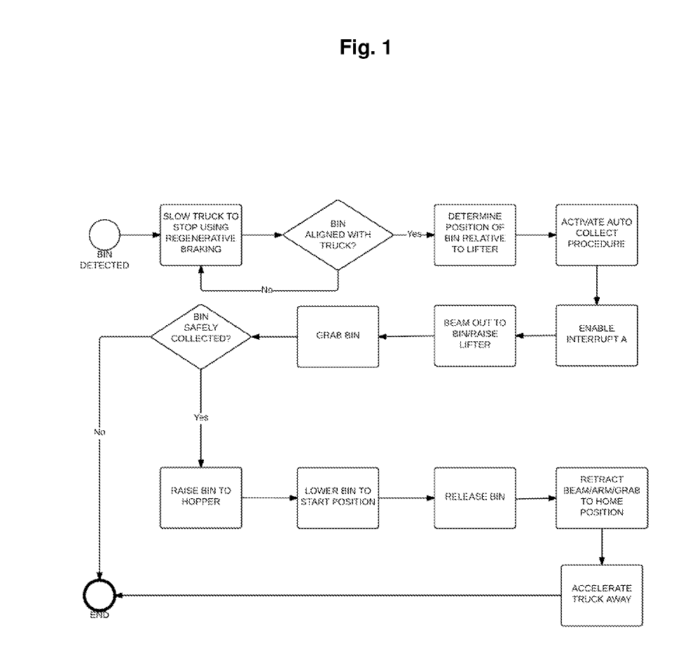

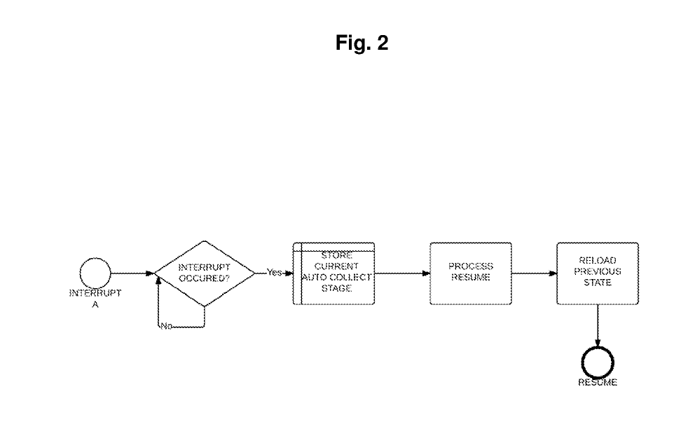

With reference to FIGS. 1 and 2, there is a rubbish collection vehicle with an automated rubbish bin collection system.

In a preferred embodiment, the driver initiates a collection process when the vehicle is in an appropriate position relative to the target rubbish bin. Initiation is achieved by pressing a button on the cabin floor. Pressing the button electronically actuates the automated rubbish bin collection system.

In a preferred embodiment, the driver of the rubbish collection vehicle drives the vehicle so that the lifting arm on the side of the vehicle is aligned with rubbish bin. The driver uses a mounted camera system with a viewing screen inside the cabin to assist the driver with the alignment. Selection of the bins to be collected can be automatic by for example, lid colour or manually by driver selection. The driver then activates the collection system.

In an alternate embodiment, the movement of the vehicle is controlled by a vehicle control system working operatively and in conjunction with the collection system. The bins can be selected automatically by lid colour or similar criterion or manually by the driver. The vehicle control system moves the vehicle so that the lifting arm aligns with the rubbish bin. The vehicle control system is activated by the driver when the vehicle is within a predetermined distance from the rubbish bin (for example 10 meters) and the vehicle is travelling below a predetermined speed (for example 10 km per hour). The collection system is automatically initiated when the vehicle stops and the lifting arm is aligned with the rubbish bin.

In both embodiments the collection system as shown in FIG. 1 automatically performs sequential steps to extend the lifting arm, grab the rubbish bin, raise the lifting arm and move the bin to at least partially invert thereby emptying the rubbish bin, lower the rubbish bin, release the rubbish bin and retract the lifting arm. These steps occur without driver assistance or intervention. These steps occur at the same reproducible pace (consistent efficiency). The driver at any stage can interrupt the process and resume the process providing a predetermined period has not expired when paused (FIG. 2).

With the initial stage of rubbish bin detection, the collection system can determine the type of rubbish bin and coordinate with the rubbish collection vehicle to open the appropriate collection hopper so that recyclable rubbish is collected in the recyclable rubbish hopper and general rubbish is collected in the general rubbish hopper.

After the collection system has performed all its steps, the collection system turns off and the driver drives to the next rubbish bin and repeats the process.

In the alternate embodiment the vehicle control system returns the vehicle to its previous acceleration and then disengages. The process is then repeated.

Having a deliberate step of activating the initiation of the collection system prevents the unintentional collection of bins while in transit or in areas where there are bins but no schedule to collect at that time. These areas include depot, transfer station and residential areas where there is no scheduled collection.

### Variations

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims of this specification the word “comprise” and variations of that word such as “comprises” and “comprising”, are not intended to exclude other additives, components, integers or steps.

1. An automated rubbish bin collection system for a rubbish collection vehicle including
detection means to detect a presence of a rubbish bin;
control means to receive input from the detection means and process the input to control the collection of the rubbish bin;
actuation means to actuate the movement of a lifting arm to grab the rubbish bin, lift the rubbish bin, and empty rubbish from the rubbish bin into a hopper of the rubbish collection vehicle; and
one or more sensors to determine a type of rubbish bin so that a correct hopper can be selected automatically for the rubbish of that bin type;
wherein from the detection of the presence of the rubbish bin, a coordinated sequence of steps automatically occurs to collect the rubbish bin, move the rubbish bin, empty the rubbish into the hopper and return the rubbish bin to an initial position.

2. An automated rubbish bin collection system as claimed in claim 1, further including a vehicle control means which controls the movement of the vehicle when the presence of the rubbish bin is detected to position the vehicle so that a lifting arm aligns with the rubbish bin.

3. An automated rubbish bin collection system as claimed in claim 1, wherein the one or more sensors include a laser distance sensor and or a camera system.

4. An automated rubbish bin collection system as claimed in claim 1, wherein the detection means includes one or more sensors to determine the presence of the rubbish bin and provide input to the control means.

5. An automated rubbish bin collection system as claimed in claim 1, wherein the control means includes a processor means that receives the input from the one or more sensors, processes the input in accordance with programming of the processor means and sends actuation signals to the actuation means.

6. An automated rubbish bin collection system as claimed in claim 1, wherein the control means provides one or more audible or visual signals to a driver of the rubbish collection vehicle to advise of the stage of the rubbish collection.

7. An automated rubbish bin collection system as claimed in claim 1, wherein the actuation means includes extension and retraction of a lifting arm, grabbing and release of a rubbish bin by the lifting arm, and raising and lowering of the lifting arm.

8. An automated rubbish bin collection system as claimed in claim 1, wherein the actuation means includes moving the lifting arm in any suitable position to empty the rubbish from the rubbish bin in a preferred hopper.

9. An automated rubbish bin collection system as claimed in claim 1, wherein the control means coordinates the movement of the lifting arm to sequentially reach for the rubbish bin, lift the rubbish bin, empty the rubbish from the rubbish bin, lower the lifting arm, release the rubbish bin and retract the lifting arm.

10. An automated rubbish bin collection system as claimed in claim 1, wherein the automated system is either not engaged or is disengaged when a driver of the rubbish collection vehicle uses a joystick or associated buttons, or if the automated system has been paused longer than for a predetermined period.

11. An automated rubbish bin collection system as claimed in claim 2, wherein the control of the vehicle by the vehicle control means is not engaged or is disengaged when the vehicle exceeds a predetermined speed, if a brake is applied by a driver of the rubbish collection vehicle, if the rubbish bin is beyond a predetermined distance from the vehicle, and or if the driver accelerates the vehicle.

12. An automated rubbish bin collection system as claimed in claim 2, wherein the vehicle control means is automatically initiated and controls the vehicle when the presence of the rubbish bin is detected.

13. (canceled)

14. A method of collecting rubbish using a rubbish collection vehicle and employing the automated rubbish bin collection system as claimed in claim 1, including the steps of:
positioning the rubbish collection vehicle adjacent the rubbish bin to align the lifting arm with the rubbish bin;
moving the lifting arm to grab and lift the rubbish bin to empty the rubbish and then lower the rubbish bin; wherein the steps occur in an automatic and sequential manner after the presence of the rubbish bin has been detected.

15. An automated rubbish bin collection system for a rubbish collection vehicle including
detection means to detect a presence of a rubbish bin;
a vehicle control means which controls movement of the vehicle when the presence of the rubbish bin is detected to position the vehicle so that a lifting arm aligns with the rubbish bin,
control means to receive input from the detection means and process the input to control the collection of the rubbish bin; and
actuation means to actuate the movement of the lifting arm to grab the rubbish bin, lift the rubbish bin and empty rubbish from the rubbish bin into a hopper of the rubbish collection vehicle,
wherein from the detection of the presence of the rubbish bin a coordinated sequence of steps automatically occurs to collect the rubbish bin, move the rubbish bin, empty the rubbish into the hopper and return the rubbish bin to the initial position.

16. An automated rubbish bin collection system as claimed in claim 15, wherein there are one or more sensors to determine a type of rubbish bin so that a correct hopper can be selected automatically for the rubbish of that bin type.

17. An automated rubbish bin collection system as claimed in claim 15, wherein the detection means includes one or more sensors to determine the presence of the rubbish bin and provide input to the control means.

18. An automated rubbish bin collection system as claimed in claim 17, wherein the one or more sensors include a laser distance sensor and or a camera system.

19. An automated rubbish bin collection system as claimed in claim 15, wherein the control means includes processor means that receives the input from one or more sensors, processes the input in accordance with programming of the processor means and sends actuation signals to the actuation means.

20. An automated rubbish bin collection system as claimed in claim 15, wherein the control means provides one or more audible or visual signals to a driver of the rubbish collection vehicle to advise of a stage of the rubbish collection.

21. An automated rubbish bin collection system as claimed in claim 15, wherein the actuation means includes extension and retraction of the lifting arm, grabbing and release of the rubbish bin by the lifting arm, and raising and lowering of the lifting arm.

22. An automated rubbish bin collection system as claimed in claim 15, wherein the actuation means includes moving the lifting arm in any suitable position to empty the rubbish from the rubbish bin in a preferred hopper.

23. An automated rubbish bin collection system as claimed in claim 15, wherein the control means coordinates the movement of the lifting arm to sequentially reach for the rubbish bin, lift the rubbish bin, empty the rubbish from the rubbish bin, lower the lifting arm, release the rubbish bin and retract the lifting arm.

24. An automated rubbish bin collection system as claimed in claim 15, wherein the automated system is either not engaged or is disengaged when a driver of the rubbish collection vehicle uses a joystick or associated buttons, or if the automated system has been paused longer than for a predetermined period.

25. An automated rubbish bin collection system as claimed in claim 15, wherein the vehicle control means is automatically initiated and controls the vehicle when the presence of the rubbish bin is detected.

26. An automated rubbish bin collection system as claimed in claim 15, wherein the control of the vehicle by the vehicle control means is not engaged or is disengaged when the vehicle exceeds a predetermined speed, if the brake is applied by a driver of the rubbish collection vehicle, if the rubbish bin is beyond a predetermined distance from the vehicle and or if the driver accelerates the vehicle.
